(19) United States
(12) Patent Application Publication
(10) Pub. No.: US 2008/0083301 A1
(43) Pub. Date: Apr. 10, 2008

(54) Bottle opener with cap catcher

(76) Inventor: Sharon C. Messina, Pittsburgh, PA (US)

Correspondence Address: JAMES RAY & ASSOCIATES, 2640 PITCAIRN ROAD, MONROEVILLE, PA, 15146, US

(21) Appl. No.: 11/973,148

(22) Filed: Oct. 5, 2007

Related U.S. Application Data
(60) Provisional application No. 60/850,493, filed on Oct. 10, 2006.

(51) Int. Cl. B67B 7/16; B65F 1/00

(52) U.S. Cl. 81/3.08; 232/43.1; 81/3.25

(57) ABSTRACT

An improved removable single housing bottle opener and cap catcher, the improvement being a hinged bottom door, and a door latching means for enabling convenient, sanitary disposal of collected bottle caps with a first part of the door latching mechanism disposed along at least one edge of the hinged bottom door and a second part disposed near the bottom of the single housing wherein the second part is sized and located to mate with the first part.

### CROSS REFERENCE TO RELATED APPLICATION

This patent application is related to and claims priority from U.S. Provisional Patent Application Ser. No. 60/850,493 filed Oct. 10, 2006.

### FIELD OF THE INVENTION

The present invention relates, in general, to opening devices for beverage bottles and, more particularly, this invention relates to an improvement to single housing openers with cap collectors that facilitates emptying.

### BACKGROUND OF THE INVENTION

Prior to the conception and development of the present invention, bartenders have had to deal with opening a large number of bottles in a short period of time. The common bottle coolers that store and refrigerate the beverage bottles typically come equipped with at least one combination bottle opener/cap catcher attached to the exterior. An example would be those from Continental Refrigerator (http://www.continental-refrig.com/). This is a very handy location for the bartender as bottles are removed from the cooler.

Various prior art patents have addressed the issue of collecting and disposing of cap removed from beverage bottle. In U.S. Pat. No. 1,547,578, Frisone discloses a bottle opener-cap receiver combination with a bottom bin that slides out for cap disposal. This device extends out rather far from the mounting surface and would create a bumping hazard in most busy bars. U.S. Pat. No. 1,929,855 discloses a bottle cap receiver which slides telescopically into and out of the housing for the opener. U.S. Pat. No. 2,029,804 discloses a bottle cap receiver that uses a chute to catch and direct the caps into the receiver. This design also protrudes rather far out from the mounting surface. U.S. Pat. No. 2,454,531 discloses use of a one piece opener and mounting plate shaped at the bottom to hold a removable cap collecting bin, which again extends somewhat from the mounting surface. The most desirable mounting surface in most cases will be the outer surface of a bottle cooler so that the bartender has only a short distance to go to the opener when removing a cold bottle.

### SUMMARY OF THE INVENTION

The present invention provides an improved removable single housing bottle opener and cap catcher. The improvement consists of a hinged bottom door, and a door latching means for enabling convenient, sanitary disposal of collected bottle caps with a first part of the door latching mechanism disposed along at least one edge of the hinged bottom door and a second part disposed near the bottom of the single housing wherein the second part is sized and located to mate with the first part.

In an alternative embodiment, the cap-removal door is a sliding cover normally over a hole in one of the side panels or over the bottom.

### OBJECTS OF THE INVENTION

It is, therefore, one of the primary objects of the present invention to make bottle opener/cap catcher combinations more sanitary.

Another object of the present invention is to provide a much easier means for emptying bottle caps from single housing opener/cap catchers.

Still another object of the present invention is to provide am improved single housing opener/cap catcher that can simply and directly replace the single housing units standard on bottle coolers thus maintaining the bottle-opening convenience and short extension from the mounting surface.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is one frontal perspective view of the improved bottle opener and cap catcher.

FIG. 2 is a rear perspective view of the housing for the bottle opener/cap catcher.

FIG. 3 is a bottom frontal perspective view with the bottom door partially open.

FIG. 4 is a bottom frontal perspective view showing a sliding door alternative.

### DETAILED DESCRIPTION OF A PRESENTLY PREFERRED EMBODIMENT OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

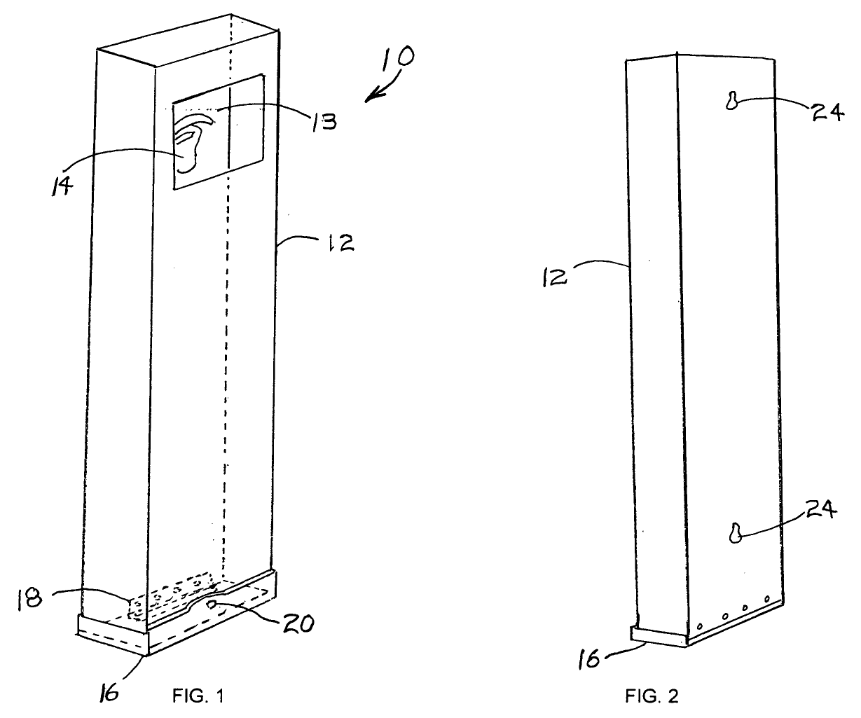

Referring initially to FIG. 1, a perspective view of the improved bottle opener/cap catcher apparatus 10 is provided. An elongated rectangular housing 12 has an open window 13 near the top giving access to a conventional opener 14 mounted on the rear inside surface. The bottom of the housing is typically closed by a hinged door 16 with a hinge 18 connecting the door 16 to the housing 12. The door is held shut by one of any number of means 20, such as a spring-like button 22 protruding from the lower front of the housing 12 engaging with an aperture in the door. Also, it could be magnets or a pimple on the back side of the door lip that engages with a detent on the bottom front surface of the housing. The door hinge 18 could also have a built-in torsion spring mechanism to hold the door closed normally or just to aid in doing so.

FIG. 2 presents a rear-side perspective view showing the two inverted keyhole mounting holes 24 in the back surface of the housing 12. The mounting holes 24 will generally be sized and spaced to be adaptable to the most common mounting hardware on commercial bottle coolers. The housing 12 will typically be sized to be a direct replacement of most standard bottle cap catchers on standard bottle coolers, but other sizes and styles would also be acceptable. The housing 12 can be readily removed by sliding up slightly and then out and away from the mounting surface. The unit is then held over a wastebasket and the door 16 is opened allowing the collected bottle caps to quickly and easily fall into the waste receptacle without ever contacting the opener mechanism.

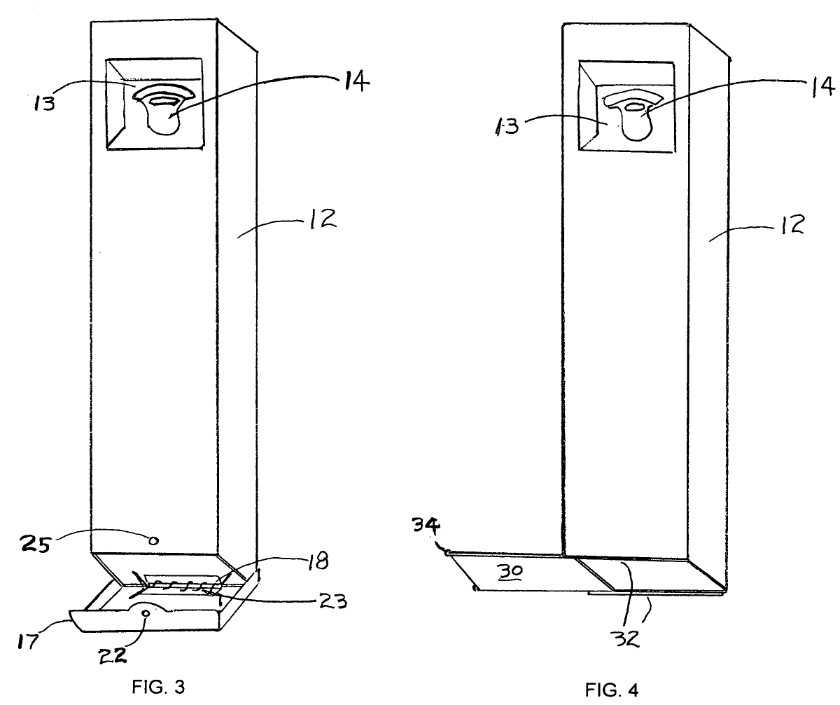

FIG. 3 provides a frontal perspective view with a bottom bias. The housing 12, constructed of metal, plastic or any durable material, has a window opening 13 near the top allowing bottle tops to be easily inserted for the rear-mounted opener 14 to pry the caps off. The removed caps fall down and collect in the lower part of the housing. A door 16 is attached to the back bottom edge with a hinge 18. The hinge may have an optional torsion spring 18 to aid in closing. The front lip 17 of the door 16 has a bump 22 protruding from the back side of the front lip 17 for engaging with the dimple 25 on the bottom front surface of the housing 12. This detent mechanism 20 is released by using one's fingers to pry outward the front of lip 17 where bump 22 is located thus releasing it from the dimple 25. This allows the door lip 17 to release and the door 16 to rotate down and back. While the door 16 is shown hinged at the back, it could alternatively be hinged at any of the other three surfaces at the bottom of the housing 12.

FIG. 4 illustrates one alternative to the hinged bottom door. In this case, the bottom is normally sealed off by a sliding door 30 that rides in tracks 32. The door can be operated by pulling or pushing on the rolled end of it 34. Sliding doors could also be placed on either of the side panels in lieu of a bottom door.

While a presently preferred embodiment of the present invention has been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. In combination with a bottle opener inside a removable elongated six-sided single housing cap catcher, the improvement comprising:
a hinged bottom door
a door latching means for enabling convenient disposal of collected bottle caps with a first part of said door latching means disposed along at least one edge of said hinged bottom door and a second part disposed proximal bottom of said single housing wherein said second part is sized and located to mate with said first part.

2. The improvement, according to claim 1, wherein said hinged bottom door has an L-shaped lip along substantially entire front and side edges.

3. The improvement, according to claim 2, wherein said L-shaped lip has an aperture engageable with said second part disposed proximal bottom of said single housing.

4. The improvement, according to claim 1, wherein said first part of said door latching means is at least one magnet adhered to said hinged bottom door and said second part is a magnetically attractable metal object adhered to said housing in alignment with said first part.

5. The improvement, according to claim 1, wherein said second part of said door latching means is at least one magnet adhered to said housing and said first part is a magnetically attractable metal object adhered to said hinged bottom door in alignment with said second part.

6. The improvement, according to claim 1, wherein said hinged bottom door has a torsion spring mechanism built into hinge to aid in closing and holding said door closed.

7. The improvement, according to claim 1, wherein said door latching means is a detent mechanism with a dimple on surface engageable with bump on another surface.

8. The improvement, according to claim 1, wherein said door latching means is latch and hook type.

9. In combination with a bottle opener inside a removable elongated six-sided single housing cap catcher, the improvement comprising:
an aperture larger than bottle-cap diameter adjacent bottom edge and in one of three outward vertical sides and bottom of said four-sided single housing cap catcher, comprising:
two parallel metal tracks
a substantially planar rectangular panel slidingly engaged with said parallel metal tracks, and
a grasping means at one end of said planar panel for enabling a user to cover and uncover said aperture.
